(19) United States
(12) Patent Application Publication
(10) Pub. No.: US 2015/0232630 A1
(43) Pub. Date: Aug. 20, 2015

(54) REACTION SYSTEM FOR PRODUCING PUR AND PIR HARD FOAM MATERIALS CONTAINING LAYER SILICATES

(71) Applicant: BAYER MATERIALSCIENCE AG, Leverkusen (DE)

(72) Inventors: Stefan Lindner, Remscheid (DE); Wolfgang Friederichs, Koln (DE); Reinhard Strey, Dormagen (DE); Thomas Scottmann, Stuttgart (DE); Diana Engelen, Leverkusen (DE)

(73) Assignee: BAYER MATERIALSCIENCE AG, Leverkusen (DE)

(21) Appl. No.: 14/434,631

(22) PCT Filed: Oct. 17, 2013
(86) PCT No.: PCT/EP2013/071736

§ 371 Date: Apr. 9, 2015

(30) Foreign Application Priority Data
Oct. 19, 2012 (EP) 12189158.4

(51) Int. Cl. C08J 9/12; C08G 18/08; C08G 18/32; C08J 9/00; C08G 18/76; C08G 18/34

(52) U.S. Cl. CPC C08J 9/122; C08G 18/7671; C08G 18/348; C08G 18/3206; C08J 9/0023; C08J 9/0066; C08G 18/14; C08G 2101/0025

(57) ABSTRACT

The invention relates to a reaction system for producing PUR and PIR hard foam materials, comprising the following components: A) a compound which is reactive towards isocyanates; B1) a surfactant component; C) a propellant in a supercritical or near-critical state; D) a polyisocyanate; and E) a layer silicate. The invention further relates to a reaction system for producing PUR and PIR hard foam materials, comprising the following components: B2) a surfactant component with functional groups which are reactive towards isocyanates; C) a propellant in a supercritical or near-critical state; D) a polyisocyanate; and E) a layer silicate. The invention further relates to a method for producing PUR and PIR hard foam materials and to PUR and PIR hard foam materials which can be obtained from the aforementioned reaction systems.

The present invention relates to a reaction system for producing rigid PUR and PIR foams, to a process for forming rigid PUR and PIR foams from such a reaction system and to rigid PUR and PIR foams obtainable from such a reaction system.

Nanocellular or nanoporous polymer foams are particularly good thermal insulation materials on the basis of theoretical considerations. This is because the internal dimensions of the foam structures are of the order of the mean free path of a gas molecule. The gas contribution to heat transfer can be reduced in this way. Polyurethanes are a group of polymers which are frequently used in thermal insulation.

Polyurethane foams are produced by reacting a polyol component, which also contains a blowing agent, with an isocyanate. The reaction of isocyanate with water gives rise to carbon dioxide, which also acts as a blowing agent.

The decisive step for foam formation, and hence for the later cell size of the cured foam, is the nucleation provided by blowing agents, since every cell in the foam has been formed from a gas bubble. A frequent observation here is that, after nucleation, no new gas bubbles are generally produced, but instead blowing agent diffuses into existing gas bubbles.

Addition of stabilizers promotes the emulsification of the various components, influences nucleation and inhibits coalescence of growing gas bubbles. They also influence cell opening. In open-cell foams, the membranes of the growing pores are opened and the struts of the pores are left standing.

One possible approach is to emulsify a supercritical blowing agent into the reaction mixture and then to cure the foam after reducing the pressure. The POSME method (principle of supercritical microemulsion expansion) is known as a variant thereof. The blowing agent is present therein in the form of a microemulsion. Microemulsions form under certain conditions which depend inter alia on the concentration of emulsifiers and on the temperature. Microemulsions are notable for their stability and for the fact that the apolar phase, i.e., the blowing agent in this case, can be present within the polar phase in very small droplets. The diameters of such droplets can range from 1 to 100 nanometers.

Sudden depressurization of CO₂-containing reaction mixtures is described in WO 2001/98389 A1. This application for a patent relates to a method for producing polyurethane slabstock foam wherein a reactive polyurethane mixture comprising carbon dioxide is abruptly depressurized from a pressure above the equilibrium solution pressure of the carbon dioxide to atmospheric pressure. As dissolved carbon dioxide escapes, the reactive liquid polyurethane mixture foams up; the foamed-up mixture is applied to a substrate and then cures to form the slabstock foam. The carbon dioxide is first fully dissolved in the reactive mixture, or in either or both of the components, polyol and isocyanate, at a pressure substantially above the equilibrium solution pressure. The pressure is then reduced to a pressure close to the equilibrium solution pressure by transiently dipping below the equilibrium solution pressure to evolve small amounts of the carbon dioxide and form a microdispersion of bubbles, mixing the components if appropriate, and the abrupt reduction in pressure to atmospheric pressure takes place before the evolved carbon dioxide is completely redissolved. However, there are no pointers here to nanocellular foams.

US 2004/0054022 A1 discloses a preparation method for rigid polyurethane foam having a density of 20 to 40 kg/m³ and an average value of 1.0 to 1.4 for the ratio of cell lengthwise-direction diameter to cross-direction diameter. The blowing agent used is CO₂ generated in the reaction between water and polyisocyanates plus supercritical, subcritical or liquid CO₂. Before mixing with the polyisocyanate, water and the liquid CO₂ are added to the polyol. Preferred CO₂ contents are between 0.5% and 3%.

DE10032334A1 describes foamed materials based on polyisocyanate polyaddition products and comprising sheet-silicates. The use of CO₂ as a physical blowing agent is not described.

EP1626063B1 describes mixtures comprising sheet-silicates whereinto at least one compound having no isocyanate-reactive hydrogen groups has been intercalated and polyether polyols having a molecular weight of greater than 2000 g/mol. This mixture can also produce polyurethane foams, the use of CO₂ as a physical blowing agent is not described. It is additionally stated that the fillers described in DE10032334A1 (e.g. Cloisit® 30A dihydroxy fatty acid expanded sheet-silicate) are very quick to segregate, resulting in a short shelf-life.

EP1209189A1 describes polymer foams containing up to 10% of nanoclay. The use of CO₂ as a physical blowing agent is not described.

The fluorine- and silicone-containing surfactants used in some of the prior art for stabilizing supercritical CO₂ in an emulsion are comparatively costly. The present invention therefore has for its object to devise a reaction system for producing a polyurethane foam having improved insulating properties. This object is achieved according to the present invention by a reaction system for producing rigid PUR and PIR foams, comprising the following components:
A) an isocyanate-reactive compound;
B1) a surfactant component;
C) a blowing agent in a supercritical or near-critical state;
D) a polyisocyanate; and
E) a sheet-silicate.

The object is further achieved by a reaction system for producing rigid PUR and PIR foams, comprising the following components:
B2) a surfactant component having isocyanate-reactive functional groups;
C) a blowing agent in a supercritical or near-critical state;
D) a polyisocyanate; and
E) a sheet-silicate.

This reaction system may further comprise A) an isocyanate-reactive compound.

The two reaction systems thus differ in that, compared with the surfactant component B1), the surfactant component B2) does have isocyanate-reactive functional groups. Hereinbelow the two surfactant components B1) and B2) are conjointly referred to as B) unless special differentiation is required.

For surfactant component B) to comprise a surfactant mixture of surfactants B1) and B2) is likewise within the purview of the present invention.

It was found that, surprisingly, the combination of a surfactant component, of a blowing agent in the supercritical or near-critical state and also of a sheet-silicate makes it possible to produce emulsions of the blowing agent in the reaction mixture which are further processable into polyurethane foams. The blowing agent is present in the emulsion in a fine state of subdivision in its own phase. A microemulsion is a particularly suitable emulsion, since the blowing agent is in a very fine state of subdivision therein and the mixture is thermodynamically stable. The sheet-silicates stabilize the emulsion by reducing the coalescence of blowing agent droplets and the diffusion of CO₂, making the production of particularly finely cellular foams possible. Use of the blowing agent mixture in the supercritical or near-critical state does away with the need for a nucleation step.

As sheet-silicates E) there may be used the known prior art silicate structures having two-dimensional sheets of SiO₄ tetrahedra. These are also known as leaf- or phyllosilicates. Examples of suitable sheet-silicates are bentonite, montmorillonite, talc, pyrophyllite, serpentinite, mica, kaolinite, muscovite or mixtures thereof. Sheet-silicates consist of sheets which may a thickness of 1 nm and a length of 75-150 nm.

The sheet-silicates E) are preferably in a modified form. Modification may consist in compounds being intercalated, i.e., inserted, between the layers. Sheet-silicates may be modified with acids, alkylammonium compounds or alkylphosphonium compounds. Preference is given to using sheet-silicates modified with alkylammonium compounds. These alkylammonium compounds are obtainable by the alkoxylation and alkylation of tallowamines, for example methyldiethanoltallowammonium salt, diethanolbenzyltallowammonium salt. Suitable sheet-silicates are available under the brand names of Cloisite®, Nanomer® or Nanofil® for example. The sheet-silicates may be incorporated in the polyol or in the isocyanate.

The proportion of sheet-silicates E) in the reaction mixture may be ≧0.1% by weight to ≦5% by weight for example.

Supercritical or near-critical blowing agent C) is used to produce the polyurethane foam.

Conditions are near-critical in the context of the present invention when the following condition is satisfied: (T_{c}−T)/T≦0.4 and/or (p_{c}−p)/p≦0.4, where T is the temperature prevailing in the process, T_{c} is the critical temperature of the blowing agent or blowing agent mixture, p is the pressure prevailing in the process and p_{c} is the critical pressure for the blowing agent or blowing agent mixture. Conditions are preferably near-critical when: (T_{c}−T)/T≦0.3 and/or (p_{c}−p)/p≦0.3 and more preferably (T_{c}−T)/T≦0.2 and/or (p_{c}−p)/p≦0.2. Without wishing to be tied to any one theory, it is believed that the choice of suitable surfactant components ensures that emulsions or microemulsions of the supercritical or near-critical blowing agent form in the phase comprising isocyanate-reactive components.

The blowing agent may preferably form its own phase in the reaction mixture. The blowing agents known to those skilled in the art may be used for polyurethane foams. Supercritical carbon dioxide can be used for example. The carbon dioxide can be formed during the reaction to form the polyurethane foam, for example as a result of the reaction of isocyanates with water or with acids. Examples of further blowing agents are linear C₁-C₆ hydrocarbons, branched C₄-C₆ hydrocarbons and cyclic C₃-C₆ hydrocarbons which may be partially or perfluorinated. Specific examples of blowing agents are methane, ethane, propane, n-butane, isobutane, n-pentane, isopentane, cyclopentane, isohexane and/or cyclohexane. Further examples are the partially or perfluorinated derivatives of methane, ethane, propane, n-butane, isobutane, n-pentane, isopentane, cyclopentane, hexane, isohexane, 2,3-dimethylbutane and/or cyclohexane. Preference is given to using carbon dioxide or a blowing agent mixture having a carbon dioxide content of at least 30% by weight, preferably at least 50% by weight and more preferably at least 70% by weight.

The use of CO₂ as blowing agent has many advantages. CO₂ is not flammable, inexpensive and environmentally friendly. Moreover, the supercritical conditions at a pressure of above 74 bar and a temperature of above 31° C. are in an acceptable range for commercial practice.

In a preferred embodiment, blowing agent C) is present in a droplet size of 1 nm to 100 nm. Droplet size may also be ≧3 nm to ≦30 nm. Droplet size may be determined using, for example, dynamic light scattering or neutron small angle scattering, and is to be understood as an average value of droplet sizes. These droplet size are present in microemulsions for example. The aforementioned droplet sizes are advantageous because when the composition is further processed into polymer foams, they ensure that the cell size in the foam obtained is small.

In a further embodiment, blowing agent C) further comprises a hydrophobic cocomponent. The cocomponent may be one compound or a mixture of various compounds. Examples are long-chain alkanes, aromatics, polysiloxanes (“silicone oils”) and long-chain organic ethers, esters and ketones. The siloxanes used contain at least 3 silicon atoms, while the aliphatic and aromatic compounds contain at least 8 carbon atoms.

A hydrophobic cocomponent as defined herein has a log K_{ow} n-octanol/water partition coefficient which under standard conditions is ≧2, preferably ≧4 and more preferably ≧5.

The cocomponent differs from the surfactant component. It does not act as a surfactant, although a possible effect as a defoamer is nonetheless also included in the present invention. More particularly, this property may be defined such that nonionic cocomponents have an HLB value ≦1 and preferably equal to 0. The HLB (hydrophilic-lipophilic balance) value describes the hydrophilic and lipophilic contents of mainly nonionic surfactants. The HLB value of nonionic surfactants can be computed as follows: HLB=20·(1−Mₕ/M), where Mₕ is the molar mass of the hydrophobic moiety of a molecule and M is the molar mass of the entire molecule.

It is further provided that the cocomponent is soluble in supercritical CO₂ at a pressure of ≧150 bar and insoluble in subcritical CO₂ at a pressure of ≦40 bar. Preferably, the cocomponent is soluble in supercritical CO₂ at a pressure of ≧140 bar and insoluble in subcritical CO₂ at a pressure of ≦60 bar. More preferably, the cocomponent is soluble in supercritical CO₂ at a pressure of ≧120 bar and insoluble in subcritical CO₂ at a pressure of ≦70 bar. “Soluble” and “insoluble” here are to be understood as meaning that when the weight fractions of cocomponent within blowing agent component C) and especially therefore within CO₂ are as specified according to the present invention, a single-phase or two-phase system would be obtained.

The hydrophobic cocomponent preferably does not contain any reactive groups for the reactive mixture, since this may lead to improved solubility in the reactive mixture.

The blowing agent is preferably mixed with components A), B) and E) and this mixture is then subsequently reacted with component D). The proportion of blowing agent in the reaction mixture comprising components A), B), C) and E) but not D) may be for example ≧3% by weight to ≦60% by weight based on the sum total of components A), B), C) and E), preferably ≧5% by weight to ≦30% by weight.

Component D) is a polyisocyanate, i.e., an isocyanate having an NCO functionality of typically 1.8 to 4.0, preferably of ≧2. The reaction system can react to give polyurethane foams or else to give polyisocyanurate foams. This reaction mixture can be produced directly in a mixing head. Examples of suitable polyisocyanates of this type are 1,4-butylene diisocyanate, 1,5-pentane diisocyanate, 1,6-hexamethylene diisocyanate (HDI), isophorone diisocyanate (IPDI), 2,2,4- and/or 2,4,4-trimethylhexamethylene diisocyanate, the isomeric bis(4,4′-isocyanatocyclohexyl)methanes or their mixtures of any desired isomer content, 1,4-cyclohexylene diisocyanate, 1,4-phenylene diisocyanate, 2,4- and/or 2,6-tolylene diisocyanate (TDI), 1,5-naphthylene diisocyanate, 2,2′- and/or 2,4′- and/or 4,4′-diphenylmethane diisocyanate (MDI) and/or higher homologs (polymeric MDI), 1,3- and/or 1,4-bis(2-isocyanatoprop-2-yl)benzene (TMXDI), 1,3-bis(isocyanatomethyl)benzene (XDI), and also alkyl 2,6-diisocyanatohexanoates (lysine diisocyanates) having C₁ to C₆ alkyl groups. An isocyanate from the diphenylmethane diisocyanate series is preferred.

In addition to the aforementioned polyisocyanates, it is also possible to make concomitant use of proportions of modified diisocyanates of uretdione, isocyanurate, urethane, carbodiimide, uretoneimine, allophanate, biuret, amide, iminooxadiazinedione and/or oxadiazinetrione structure and also unmodified polyisocyanate having more than 2 NCO groups per molecule, for example 4-isocyanatomethyl-1,8-octane diisocyanate (nonane triisocyanate) or triphenylmethane 4,4′,4″-triisocyanate.

The isocyanate can be a prepolymer obtainable by reacting an isocyanate having an NCO functionality of in particular 1.8 to 4.0, preferably of ≧2 and polyols having a molecular weight of ≧62 g/mol to ≦8000 g/mol and OH functionalities of ≧1.5 to ≦6.

It will be appreciated that still further customary auxiliary and added substances such as catalysts, flame retardants, release agents, fillers and the like can be used to produce the polyurethane foam.

The number of NCO groups in polyisocyanate component D) and the number of isocyanate-reactive groups of component A) and component B) can be in a numerical ratio of ≧50:100 to ≦500:100 relative to each other for example. This index can also be in a range of ≧80:100 to ≦330:100 or else ≧100:100 to ≦160:100.

To produce a foam from the reaction system of the present invention, for example, all the components other than the polyisocyanate component can be initially charged to a pressurized mixing head, in particular a high-pressure mixing head under supercritical or near-critical conditions for the blowing agent, and can then be admixed with polyisocyanate D). The mixing then takes place in the pressurized mixing head.

Suitable pressures for producing the polyurethane foam can be in the range from ≧40 bar to ≦300 bar for example. Suitable temperatures are ≧10° C. to ≦80° C. for example, preferably ≧25° C. to ≧60° C. Particular preference is given to pressures and temperatures above the critical point of CO₂, i.e., ≧73.75 bar and ≧31° C.

Useful NCO-reactive compounds A) include especially polyols, polyamines, polyamino alcohols and polythiols.

Examples of polyamines are ethylenediamine, 1,2-diaminopropane, 1,3-diaminopropane, 1,4-diaminobutane, 1,6-diaminohexane, isophoronediamine, an isomeric mixture of 2,2,4- and 2,4,4-trimethylhexamethylenediamine, 2-methylpentamethylenediamine, diethylenetriamine, 1,3-xylylenediamine, 1,4-xylylenediamine, α,α,α′,α′-tetramethyl-1,3-xylylenediamine, α,α,α′,α′-tetramethyl-1,4-xylylenediamine, 4,4′-diaminodicyclohexylmethane, diethylmethylbenzenediamine (DETDA), 4,4′-diamino-3,3′-dichlorodiphenylmethanes (MOCAs), dimethylethylenediamine, 1,4-bis(aminomethyl)cyclohexane, 4,4′-diamino-3,3′-dimethyldicyclohexylmethane and 4,4′-diamino-3,5-diethyl-3′,5′-diisopropyl-dicyclohexylmethane. Polymeric polyamines such as polyoxyalkyleneamines are also suitable.

Examples of amino alcohols are N-aminoethylethanolamine, ethanolamine, 3-aminopropanol, neopentanolamine and diethanolamine.

Examples of polythiols are di(2-mercaptoethyl) ether, pentaerythritol tetrakisthioglycolate, pentaerythritol tetrakis(3-mercaptopropionate) and 1,2-bis((2-mercaptoethyl)thio)-3-mercaptopropane.

In a preferred embodiment of the reaction system according to the present invention, compound A) and/or compound B2) has a functionality with regard to isocyanates in the range from 1.8 to 6.0, especially ≧2.0.

Polyols can for example have a number-average molecular weight Mₙ of ≧62 g/mol to ≦8000 g/mol, preferably of ≧90 g/mol to ≦5000 g/mol and more preferably of ≧92 g/mol to ≦1000 g/mol. In the case of a single added polyol, the OH number of component A) indicates the OH number thereof. In the case of mixtures, the average OH number is reported. This value can be determined in accordance with DIN 53240. The average OH functionality of the recited polyols is for example ≧2, for example in a range from ≧2 to ≦6, preferably from ≧2.1 to ≦4 and more preferably from ≧2.2 to ≦3.

Examples of polyether polyols that can be used are the polytetramethylene glycol polyethers that are obtainable through polymerization of tetrahydrofuran via cationic ring opening.

Useful polyether polyols further include addition products of styrene oxide, ethylene oxide, propylene oxide, butylene oxides and/or epichlorohydrin onto di- or polyfunctional starter molecules.

Examples of suitable starter molecules are water, ethylene glycol, diethylene glycol, butyl diglycol, glycerol, diethylene glycol, trimethylolpropane, propylene glycol, pentaerythritol, sorbitol, sucrose, ethylenediamine, toluenediamine, triethanolamine, 1,4-butanediol, 1,6-hexanediol and also low molecular weight hydroxyl-containing esters of polyols of this type with dicarboxylic acids.

Suitable polyester polyols include polycondensates of di- and also tri- and tetraols and di- and also tri- and tetracarboxylic acids or of hydroxycarboxylic acids or of lactones. Instead of the free polycarboxylic acids it is also possible to use the corresponding polycarboxylic anhydrides, or corresponding polycarboxylic esters of lower alcohols, to produce the polyesters.

Examples of suitable diols are ethylene glycol, butylene glycol, diethylene glycol, triethylene glycol, polyalkylene glycols such as polyethylene glycol, also 1,2-propanediol, 1,3-propanediol, 1,3-butanediol, 1,4-butanediol, 1,6-hexanediol and isomers, neopentyl glycol or neopentyl glycol hydroxypivalate. Other polyols that can be used, alongside these, are those such as trimethylolpropane, glycerol, erythritol, pentaerythritol, trimethylolbenzene or trishydroxyethyl isocyanurate.

Examples of polycarboxylic acids that can be used are phthalic acid, isophthalic acid, terephthalic acid, tetrahydrophthalic acid, hexahydrophthalic acid, cyclohexanedicarboxylic acid, adipic acid, azelaic acid, sebacic acid, glutaric acid, tetrachlorophthalic acid, maleic acid, fumaric acid, itaconic acid, malonic acid, suberic acid, succinic acid, 2-methylsuccinic acid, 3,3-diethylglutaric acid, 2,2-dimethylsuccinic acid, dodecanedioic acid, endomethylenetetrahydrophthalic acid, dimer fatty acid, trimer fatty acid, citric acid, or trimellitic acid. It is also possible to use the corresponding anhydrides as acid source.

To the extent that the average functionality of the polyol to be esterified is ≧2, it is also possible to make additional concomitant use of monocarboxylic acids such as benzoic acid and hexanecarboxylic acid.

Examples of hydroxycarboxylic acids which can be used concomitantly as reactants during the production of a polyester polyol having terminal hydroxyl groups are hydroxycaproic acid, hydroxybutyric acid, hydroxydecanoic acid, hydroxystearic acid and the like. Suitable lactones include caprolactone, butyrolactone and homologs.

Polycarbonate polyols that can be used are hydroxyl-containing polycarbonates, for example polycarbonate diols. These are obtainable through reaction of carbonic acid derivatives, such as diphenyl carbonate, dimethyl carbonate or phosgene, with polyols, preferably diols, or through the copolymerization of alkylene oxides such as propylene oxide with CO₂.

Examples of diols of this type are ethylene glycol, 1,2-propanediol, 1,3-propanediol, 1,3-butane-diol, 1,4-butanediol, 1,6-hexanediol, 1,8-octanediol, neopentyl glycol, 1,4-bishydroxy-methylcyclohexane, 2-methyl-1,3-propanediol, 2,2,4-trimethyl-1,3-pentanediol, dipropylene glycol, polypropylene glycols, dibutylene glycol, polybutylene glycols, bisphenol A and lactone-modified diols of the aforementioned type.

Instead of or in addition to pure polycarbonate diols, it is also possible to use polyether-polycarbonate diols.

Polyetherester polyols that can be used are compounds that contain ether groups, ester groups and OH groups. Suitable compounds for producing the polyetherester polyols are organic dicarboxylic acids having up to 12 carbon atoms, preferably aliphatic dicarboxylic acids having ≧4 to ≦6 carbon atoms or aromatic dicarboxylic acids, which are used individually or in a mixture. Examples that may be mentioned are suberic acid, azelaic acid, decanedicarboxylic acid, maleic acid, malonic acid, phthalic acid, pimelic acid and sebacic acid and also particularly glutaric acid, fumaric acid, succinic acid, adipic acid, phthalic acid, terephthalic acid and isoterephthalic acid. Examples of derivatives of said acids that can be used are their anhydrides and also their esters and hemiesters with low molecular weight monohydric alcohols having ≧1 to ≦4 carbon atoms.

Another component used for producing the polyetherester polyols are polyether polyols obtained through alkoxylation of starter molecules such as polyhydric alcohols. The starter molecules are at least difunctional, but can also optionally contain proportions of starter molecules of higher functionality, especially trifunctional starter molecules.

Examples of starter molecules are diols having number-average molecular weights Mₙ of preferably ≧18 g/mol to ≦400 g/mol or of ≧62 g/mol to ≦200 g/mol such as 1,2-ethanediol, 1,3-propanediol, 1,2-propanediol, 1,4-butanediol, 1,5-pentenediol, 1,5-pentanediol, neopentyl glycol, 1,6-hexanediol, 1,7-heptanediol, 1,8-octanediol, 1,10-decanediol, 2-methyl-1,3-propane-diol, 2,2-dimethyl-1,3-propanediol, 3-methyl-1,5-pentanediol, 2-butyl-2-ethyl-1,3-propanediol, 2-butene-1,4-diol and 2-butyne-1,4-diol, ether diols such as diethylene glycol, triethylene glycol, tetraethylene glycol, dibutylene glycol, tributylene glycol, tetrabutylene glycol, dihexylene glycol, trihexylene glycol, tetrahexylene glycol and oligomer mixtures of alkylene glycols, such as diethylene glycol.

Polyols having number-average functionalities of ≧2 to ≦8, or of ≧3 to ≦4 can also be used concomitantly alongside the diols, examples being 1,1,1-trimethylolpropane, triethanolamine, glycerol, sorbitan and pentaerythritol, and also polyethylene oxide polyols started on triols or tetraols and having average molecular weights of preferably ≧62 g/mol to ≦400 g/mol or of ≧92 g/mol to ≦200 g/mol.

Polyetherester polyols are also obtainable through the alkoxylation of reaction products which are obtained by the reaction of organic dicarboxylic acids and diols. Examples of derivatives of said acids that can be used are their anyhdrides, for example phthalic anhydride.

Polyacrylate polyols are obtainable through free-radical polymerization of hydroxyl-containing olefinically unsaturated monomers or through free-radical copolymerization of hydroxyl-containing olefinically unsaturated monomers with optionally other olefinically unsaturated monomers. Examples thereof are ethyl acrylate, butyl acrylate, 2-ethylhexyl acrylate, isobornyl acrylate, methyl methacrylate, ethyl methacrylate, butyl methacrylate, cyclohexyl methacrylate, isobornyl methacrylate, styrene, acrylic acid, acrylonitrile and/or methacrylonitrile. Suitable hydroxyl-containing olefinically unsaturated monomers are in particular 2-hydroxyethyl acrylate, 2-hydroxyethyl methacrylate, the hydroxypropyl acrylate isomer mixture obtainable through addition of propylene oxide onto acrylic acid and also the hydroxypropyl methacrylate isomer mixture obtainable through addition of propylene oxide onto methacrylic acid. Terminal hydroxyl groups can also be present in protected form. Suitable free-radical initiators are those from the group of the azo compounds, e.g., azoisobutyronitrile (AIBN), or from the group of the peroxides, e.g., di-tert-butyl peroxide.

According to the present invention, surfactant component B), i.e., B1) and/or B2), comprises a hydrophilic portion and a hydrophobic portion. Surfactant component B) may in principle comprise anionic, cationic, amphoteric and/or nonionic surfactants. In surfactants, the HLB (hydrophilic-lipophilic balance) value defines the mass ratio between the hydrophilic and lipophilic moieties. The HLB value of nonionic surfactants can be computed as follows: HLB=20·(1−Mₕ/M), where Mₕ is the molar mass of the hydrophobic moiety of a molecule and M is the molar mass of the entire molecule. The HLB value of an isocyanate-reactive surfactant component B2) may be for example from 4 to 18, preferably from 8 to 16 and more preferably from 10 to 15.

In one embodiment, the hydrophobic portion of surfactant component B1) and/or B2) comprises a saturated or unsaturated hydrocarbonaceous chain of at least 4 carbon atoms, preferably at least 6 carbon atoms, more preferably at least 12 carbon atoms and yet more preferably at least 14 carbon atoms. Saturated or unsaturated hydrocarbonaceous chains in surfactant component B) are obtainable, for example, by alkoxylation of fatty acid alcohols or fatty acids with ethylene oxide or propylene oxide.

Saturated hydrocarbonaceous chains in surfactant component B1) and/or B2) are also obtainable, for example, by esterification of polyols with saturated fatty acids. 2-Ethylhexanoic acid is one example of a suitable saturated fatty acid. Unsaturated hydrocarbonaceous chains, in addition to units of the form —(H)C═C(H)—, may of course also contain saturated units —CH₂—. This can be achieved by esterification with unsaturated fatty acids. Oleic acid ((Z)-9-octadecenoic acid) is one example of a suitable unsaturated fatty acid. Mixtures of fatty acids, obtained from natural oils such as soybean oil or rapeseed oil for example, can also be used.

The hydrophilic region of isocyanate-reactive compound B2) preferably comprises ethylene oxide units -[—CH₂—CH₂—O-]- and/or carboxylic ester units. Compound B2) is obtainable, for example, by partially alkoxylating an at least trifunctional polyol, so one OH group of the polyol is available for an esterification with a fatty acid. Compound B2) is further obtainable by an esterification of oleic acid with adipic acid, trimethylolpropane and/or diethylene glycol, for example. The average number of OH groups per molecule of isocyanate-reactive compound B2) is preferably in the range from 1.0 to 5 and more preferably in the range from 2.0 to 3.5.

The proportion of intro-esterified fatty acid in the reaction mixture comprising components A), B), C), D) and E) may be for example ≧0.5% by weight to ≦25% by weight. Preferred proportions are ≧2% by weight to ≦15% by weight, while ≧4% by weight to ≦10% by weight are more preferable.

Suitable surfactants B) are initially not subject to any restrictions with regard to their selection.

The surfactants ideally enable the blowing agent to form emulsions or microemulsions in the isocyanate-reactive phase. Particularly suitable surfactants include, for example, alkoxylated alkanols such as ethers of linear or branched alkanols having ≧6 to ≦30 carbon atoms with polyalkylene glycols having ≧5 to ≦100 alkylene oxide units, alkoxylated alkylphenols, alkoxylated fatty acids, carboxylic esters of an alkoxylated sorbitan (especially Polysorbate 80), fatty acid esters, polyalkyleneamines, alkyl sulfates, phosphatidylinositols, fluorinated surfactants, surfactants comprising polysiloxane groups such as polysiloxane-polyoxyalkylene copolymers and/or bis(2-ethyl-1-hexyl) sulfosuccinate. Examples of surfactants B1) are alkyl sulfates or bis(2-ethyl-1-hexyl) sulfosuccinate. Examples of surfactants B2) are alkoxylated alkanols, alkoxylated alkylphenols, alkoxylated fatty acids, fatty acid esters esterified with diols or triols.

Surfactant component B) is preferably a 20° C. liquid compound, preferably having a viscosity of less than 15 000 mPas, more preferably below 5000 mPas. Viscosity can be determined according to DIN 53019 for example.

Surfactant component B) may for example have a number-average molecular weight Mₙ of ≧100 g/mol to ≦8000 g/mol, preferably of ≧200 g/mol to ≦5000 g/mol and more preferably of ≧500 g/mol to ≦2500 g/mol.

The invention further provides a process for producing rigid PUR and PIR foams, which comprises the components of a reaction system according to the present invention being mixed and reacted with each other, wherein in particular first a mixture of all the components with the exception of polyisocyanate D) is produced in a pressurized mixing head under supercritical or near-critical conditions for blowing agent C) and this mixture is then admixed with polyisocyanate D). The exportation of the mixture from the mixing head is preferably performed with lowering to atmospheric pressure or below. Polyisocyanate D) is typically admixed in the mixing head.

Atmospheric pressure herein is to be understood as meaning in particular a pressure of ≧0.9 bar to ≦1.1 bar. The blowing agent transitions into the subcritical and preferably into the gaseous state. For example, the reaction mixture emerging from the mixing head may simply be imported into an open mold or be used in a continuous manner for the manufacture of slabs, for example through free-foaming systems or twin-conveyor systems. The present invention expressly also comprehends the possibility that, between the emergence of the reaction mixture from the mixing head and the depressurization to atmospheric pressure, there can also be intermediate stations where the prevailing pressure is between the pressure in the mixing head and atmospheric pressure.

In one embodiment of the process according to the present invention, a pressure of ≧40 bar to ≦200 bar, preferably a pressure of ≧60 bar to ≦150 bar, more preferably a pressure of ≧70 bar to ≦120 bar and very preferably ≧80 bar to ≦120 bar prevails after the step of providing the mixture of compounds A), B), C), D) and E). This state may prevail particularly in a mixing head and downstream of a mixing head. Pressures of this type will maintain supercritical or near-critical conditions for the blowing agent used.

In a further embodiment of the process according to the present invention, means are disposed in the mixing head or downstream of the mixing head for elevating the flow resistance in the step of discharging the mixture comprising components A), B), C), D) and E). Examples of such means include perforated plates, grids, slot diffusers and/or sieves arranged downstream of a mixing chamber of the mixing head. Flow resistance elevation intentionally influences the pressure of the reaction mixture prior to discharge from the mixing head. The pressure thus set can be lower than the pressure during the mixing of the components of the reaction mixture. This makes it possible to influence the formation and expansion of blowing agent droplets or of small bubbles of blowing agent. Means of this type are described in WO 2001/98389 A1 for example.

The present invention further provides a rigid foam obtainable by mixing and reacting the components of a reaction system according to the present invention. The rigid foam is a polyurethane foam and/or polyisocyanurate foam having an apparent density of 20 kg/m³ to 160 kg/m³ in particular. Apparent density may be determined to DIN EN 1602 and is preferably in the range from 30 kg/m³ to 120 kg/m³ and more preferably in the range from 50 kg/m³ to 80 kg/m³. Preferred uses for the foam of the present invention are in thermal insulation, for example for the manufacture of insulation slabs, metal-faced panels or for refrigerator insulation.

The invention further provides for the use in the manufacture of rigid PUR and PIR foams of a reaction system comprising the following components:

A) an isocyanate-reactive compound;
B1) a surfactant component;
C) a blowing agent in a supercritical or near-critical state;
D) a polyisocyanate; and
E) a sheet-silicate.

The present invention provides for the use in the manufacture of rigid PUR and PIR foams of a reaction system comprising the following components:

B2) a surfactant component having isocyanate-reactive functional groups;
C) a blowing agent in a supercritical or near-critical state;
D) a polyisocyanate; and
E) a sheet-silicate.

This reaction system may further comprise A) an isocyanate-reactive compound.

In an example of a recipe, components A), B), C), D) and E) are present in the following amounts:

A) ≧0% by weight to ≦45% by weight
B1) ≧1% by weight to ≦45% by weight
C) ≧1% by weight to ≦40% by weight
D) ≧30% by weight to ≦70% by weight
E) ≧0.1% by weight to ≦5% by weight
or
A) ≧0% by weight to ≦45% by weight
B2) ≧1% by weight to ≦65% by weight
C) ≧1% by weight to ≦40% by weight
D) ≧30%/by weight to ≦70% by weight
E) ≧0.1% by weight to ≦5% by weight

These % by weight amounts add up to ≦100% by weight. Preferred amounts for the components are:

A) ≧20% by weight to ≦40% by weight
B1) and/or B2) ≧5% by weight to ≦40% by weight
C) ≧3% by weight to ≦20% by weight
D) ≧40% by weight to ≦60% by weight
E) ≧0.5% by weight to ≦2% by weight

The examples which follow are offered by way of elucidation in conjunction with the figure, not limitation of the present invention.

### Raw Materials Used:

Desmophen® VP.PU 1431: bifunctional polyetherester polyol, EO adduct onto a mixture of phthalic anhydride, diethylene glycol and ethylenediamine, with an OH number of 275 to 325 mg KOH/g and a viscosity of 6.5±1.3 Pa s at 25° C.; Bayer MaterialScience AG.

Desmorapid® 726b: catalyst from Bayer MaterialScience AG

DBTDL: dibutyltin dilaurate, catalyst

Desmodur® VP.PU 22HK75: Desmodur® VP.PU 22HK75, a dark brown liquid of medium viscosity, is a partially modified mixture of diphenylmethane 4,4′-diisocyanate (MDI) with isomers and higher-functional homologs. The NCO content of the prepolymer is 27.3 to 28.3 wt % and the viscosity is 0.8 to 1.3 Pa·s at 25° C.; Bayer MaterialScience AG.

Surfactant 1: a surfactant based on ricinoleic acid, adipic acid, trimethylolpropane and diethylene glycol. The surfactant was formed from 649 g of adipic acid, 377 g of ricinoleic acid, 458 g of diethylene glycol and 200 g of trimethylolpropane with 20 ppm of tin(II) chloride dihydrate. The reaction ran for 42 hours at 200° C. in vacuo, the resulting water was distilled off. The measured OH number is 152 mg KOH/g coupled with an average functionality of 3 and an HLB value of 15. So surfactant component B2) is concerned. The viscosity is 3.87 Pa s at 25° C.

Cloisite® 30B: montmorillonite sheet-silicate modified with a quaternary ammonium salt. The quaternary ammonium salt is a methyl dihydroxyethyltallowammonium compound. The tallow moiety consists of a mixture of C18, C16 and C14 chains. The quaternary ammonium salt is hydroxyl-functionalized. Product from Southern Clay Products, Inc.

### EXAMPLES

### Microemulsion

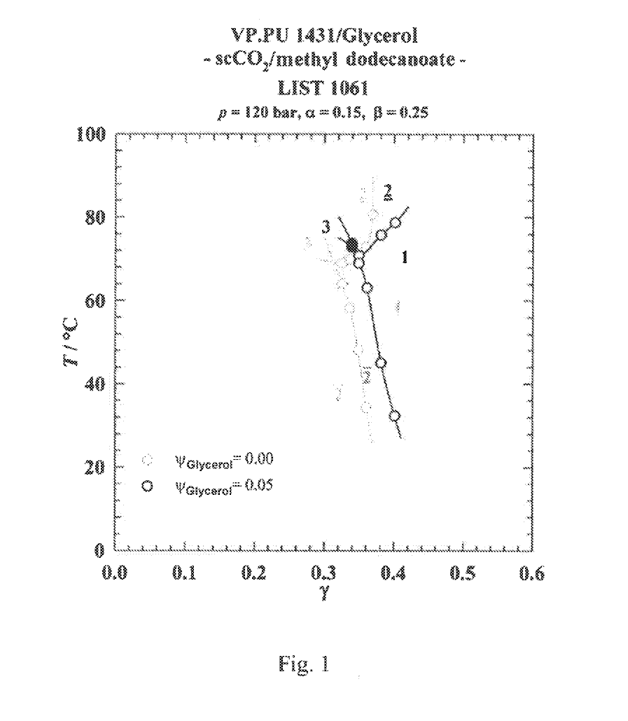

The value α in the examples which follow and FIG. 1 indicates the relative weight fraction of blowing agent, i.e., of the apolar phase, in the polyol/blowing agent mixture. The value β indicates the relative weight fraction of co-blowing agent component (here: methyl dodecanoate) in the blowing agent mixture. The value Ψ indicates the mass fractions of the individual components in the polar phase. The value γ indicates the relative weight fraction of surfactant component in the overall composition. In FIG. 1, reference sign 1 denotes a single-phase sector in which microemulsions occur and reference sign 2 denotes a two-phase sector, where the surfactant is either in the polar phase or in the apolar phase.

The individual examples each relate to certain polyol/blowing agent/surfactant systems. Within the examples, formulations differing in the proportion Ψ of glycerol were more particularly characterized. For each constant proportion α, the proportion γ of surfactant component was varied. The composition of the surfactant component itself was kept constant in the respective examples. The temperature of the system was recorded and connecting lines were interpolated between the measurement points, in order to determine the boundaries between the single-, two- and three-phase sectors. This resulted in a diagram which is comparable to a Kahlweit-Fisch diagram (M. Kahlweit, R. Strey, Angewandte Chemie International Edition, volume 28(8), page 654 (1985)). The point of intersection of the connecting lines is of particular interest for characterizing the system. Once the position of the intersection point in the coordinate system of γ and T is known, a microemulsion can be expected to occur at a minimally greater proportion γ of surfactant.

### Shelf-Life:

To test the shelf-life, Cloisite 30B sheet-silicate were incorporated into the polyol mixtures using a high-speed stirrer.

TABLE 1

| Components | Example 1 | Comparator 1 |
|---|---|---|
| VP.PU 1431 | 27.90 | 27.90 |
| glycerol | 1.47 | 1.47 |
| surfactant 1 | 34.54 | |
| Cloisite 30B | 1.35 | 0.62 |

The formulation of Example 1 contains a surfactant having a fatty acid moiety as hydrophobic group. A microemulsion is obtainable from the formulation of Example 1 on admixture on admixture of CO₂. The mixture of Example 1 forms a stable mixture. No separation is visible to the naked eye even after more than 4 weeks.

The formulation from Comparator 1 is prepared similarly to Example 1. Despite the distinctly higher viscosity of the formulation from Comparator 1, the visual impression is distinctly worse after just 3 days. There are first signs of sheet-silicate deposits on the vessel wall.

The polyol formulation of Example 1 thus provides storage-stable polyol/sheet-silicate mixtures.

### Examples 2 and 3 and Also Comparative Examples Comparator 2 to Comparator 3

CO₂-blown polyurethane foams were produced according to the recipes recited below in Tables 2. Unless otherwise stated, quantities are given in parts by weight. The mixture of isocyanate-reactive compound A), surfactant component B) and sheet-silicates E) was mixed with ancillary components such as catalysts and methyl laurate using a high-speed stirrer at 800 revolutions per minute for 20 minutes. In the mixture obtained, which is stable in storage, the sheet-silicates form a uniform fine dispersion. This mixture was used as polyol component in a standard high-pressure mixing rig and mixed therein with the CO₂ as blowing agent C) at an initial pressure of 120 bar. This meant that there were supercritical conditions for the blowing agent. This mixture was mixed in a high-pressure mixing head with a polyisocyanate D), which is fed at an initial pressure of 120 bar. Shot quantity is 60 g/s and shot time is 10 seconds. The efflux pipe of the mixing head had an internal diameter of 8.5 mm and a length of about 50 cm.

A perforated plate having the hole size specified in the tables was fitted in the efflux pipe downstream of the mixing head in Examples 2 and 3 and Comparative Examples 2 and 3. This made it possible to set the pressure in the mixing head in a controlled manner and achieve a slower pressure reduction in the reaction mixture. The perforated plate makes it possible to set the pressure in a controlled manner. Comparative Examples 2-3, where sheet-silicate E was omitted in contradistinction to Examples 2 and 3, have a distinctly higher apparent density and, what is more, Comparative Examples 2 to 3 are coarsely cellular.

The table which follows lists the reaction systems produced and also the rigid foams produced therefrom:

TABLE 2

| | Exam- | Exam- | Compar- | Compar- |
|---|---|---|---|---|
| Components | ple 2 | ple 3 | ator 2 | ator 3 |
| VP.PU 1431 | 29.01 | 27.93 | 29.35 | 28.25 |
| glycerol | 1.53 | 1.47 | 1.54 | 1.49 |
| surfactant 1 | 35.91 | 34.58 | 36.33 | 34.97 |
| Desmorapid 726b | 0.46 | 0.44 | 0.46 | 0.45 |
| DBTDL | 0.09 | 0.09 | 0.09 | 0.09 |
| Cloisite 30B | 1.4 | 1.35 | 0 | 0 |
| methyl laurate | 1.07 | 1.03 | 1.08 | 1.04 |
| CO₂ | 4.31 | 4.15 | 4.36 | 4.19 |
| VP.PU 22HK75 | 46.23 | 48.97 | 46.78 | 49.52 |
| Process parameters | | | | |
| NCO/OH ratio | 1.0 | 1.1 | 1.0 | 1.1 |
| isocyanate temperature [° C.] | 27 | 27 | 28 | 28 |
| polyol temperature [° C.] | 29 | 29 | 30 | 30 |
| pressure in mixing chamber | 72-68 | 70-67 | 63-69 | 67-71 |
| [bar] | | | | |
| perforated plate [mm] | 0.9 | 0.9 | 0.9 | 0.9 |
| pipe diameter [mm] | 8.5 | 8.5 | 8.5 | 8.5 |
| PUR foam properties | | | | |
| free-rise density of core | 102 | 89 | 115 | 114 |
| [kg/m³] | | | | |
| comment | finely | finely | coarsely | coarsely |
| | cellular | cellular | cellular | cellular |
| | | | with | with |
| | | | voiding | voiding |
| Emulsion parameters | | | | |
| γ value of CO₂-polyol | 0.5 | 0.5 | 0.5 | 0.5 |
| emulsion | | | | |
| weight fraction of CO₂ [%] | 3.6 | 3.5 | 3.6 | 3.5 |
| weight fraction of fatty acid | 7.5 | 7.2 | 7.6 | 7.3 |
| [%] | | | | |
| weight fraction of surfactant | 29.9 | 28.8 | 30.3 | 29.1 |
| 1 [%] | | | | |
| weight fraction of Cloisite | 1.2 | 1.1 | 0.0 | 0.0 |
| 30B [%] | | | | |

The summarized results in Table 2 verify that the reaction systems of the present invention lead not only to an improved shelf-life but also to very finely cellular foams which accordingly also have superior thermal insulation properties. Moreover, the foams of the present invention are notable for low density.

1-15. (canceled)

16. A reaction system for producing rigid PUR and PIR foams, comprising the following components:
A) an isocyanate-reactive compound;
B1) a surfactant component;
C) a blowing agent in a supercritical or near-critical state;
D) a polyisocyanate; and
E) a sheet-silicate.

17. A reaction system for producing rigid PUR and PIR foams, comprising the following components:
B2) a surfactant component having isocyanate-reactive functional groups;
C) a blowing agent in a supercritical or near-critical state;
D) a polyisocyanate; and
E) a sheet-silicate.

18. The reaction system as claimed in claim 16, wherein the reaction system further comprises:
B2) a surfactant component having isocyanate-reactive functional groups.

19. The reaction system as claimed in claim 17, wherein the reaction system further comprises:
A) an isocyanate-reactive compound.

20. The reaction system as claimed in claim 16, wherein the reaction system comprises from 1 to 65 wt % of surfactant component B1) and/or B2) based on the reaction system.

21. The reaction system as claimed in claim 16, wherein the surfactant component B1) and/or B2) is selected from nonionic surfactants,

22. The reaction system as claimed in claim 16, wherein the compound A) and/or the compound B2) has a functionality with regard to isocyanates of from 1.8 to 6.0.

23. The reaction system as claimed in claim 16, wherein the blowing agent C) selected from the group consisting of linear, branched or cyclic C1-C6 hydrocarbons, linear, branched or cyclic C1-C6 (hydro)fluorocarbons, N₂, O₂, argon and/or CO₂, wherein the proportion of CO₂ in the blowing agent mixture is at least 30 wt %.

24. The reaction system as claimed in claim 16, wherein the blowing agent C) is present in the reaction system in the form of droplets, wherein the droplet size is from 1 nm to 100 nm.

25. The reaction system as claimed in claim 16, wherein the blowing agent C) further comprises a hydrophobic co-component.

26. The reaction system as claimed in claim 16, wherein the compound B2) has an average number of 1.0 to 5 OH groups per molecule, and wherein at least one of the OH groups is esterified with a fatty acid.

27. A process for producing rigid PUR and PIR foams, comprising mixing and reacting with each other the components of a reaction system as claimed in claim 16, wherein in particular first a mixture of all the components with the exception of polyisocyanate D) is produced in a pressurized mixing head under supercritical or near-critical conditions for blowing agent C) and this mixture is then admixed with polyisocyanate D) and exportation from the pressurized mixing head is performed with lowering to atmospheric pressure or below, the reaction of the components of the reaction system being carried out in particular at a pressure of 40 to 300 bar and/or a temperature of 10 to 80° C.

28. A rigid foam obtained by mixing and reacting the components of a reaction system as claimed in claim 16.

29. A method comprising manufacturing a rigid PUR and PIR foam with a reaction system comprising the following components:
A) an isocyanate-reactive compound;
B1) a surfactant component;
C) a blowing agent in a supercritical or near-critical state;
D) a polyisocyanate; and
E) a sheet-silicate.

30. A method comprising manufacturing a rigid PUR and PIR foams with a reaction system comprising the following components:
B2) a surfactant component having isocyanate-reactive functional groups;
C) a blowing agent in a supercritical or near-critical state;
D) a polyisocyanate; and
E) a sheet-silicate.

31. The reaction system as claimed in claim 21, wherein the HLB value is from 4 to 18 as per the equation HLB=20*(1−Mₕ/M) where Mₕ=molar mass of hydrophobic moiety and M=overall mass of nonionic surfactant.

32. The reaction system as claimed in claim 25, wherein the co-component is selected from the group consisting of long-chain alkanes having at least 8 carbon atoms, aromatics having at least 8 carbon atoms, polysiloxanes (“silicone oils”) having at least 3 silicon atoms and long-chain organic ethers carbon atoms, esters and ketones having at least 8.
